(19) United States
(12) Patent Application Publication
(10) Pub. No.: US 2009/0032137 A1
(43) Pub. Date: Feb. 5, 2009

(54) Apparatus And Method

(76) Inventors: John Paul Ducsay, Swartz Creek, MI (US); Anthony John Lukasiewicz, Howell, MI (US)

Correspondence Address: WARN, HOFFMANN, MILLER & LALONE, .P.C, PO BOX 70098, ROCHESTER HILLS, MI, 48307, US

(21) Appl. No.: 11/667,744

(22) PCT Filed: Nov. 16, 2005
(86) PCT No.: PCT/GB05/04402

§ 371 Date: Feb. 28, 2008

Related U.S. Application Data
(60) Provisional application No. 60/628,318, filed on Nov. 16, 2004.
(60) Provisional application No. 60/706,933, filed on Aug. 10, 2005.

(51) Int. Cl. B65B 55/02; B08B 3/04; B65B 1/00

(52) U.S. Cl. 141/85; 134/22.18

(57) ABSTRACT

Apparatus (20) for filling cartons (22) in a sterile, contaminant-free environment comprises an enclosure (26) which at least partially surrounds a carton filler nozzle (24). A carton opening (32) formed in the bottom of the enclosure (26) is shaped to receive an open-ended carton (22) into a position for filling. Guides (44) machined into interior surfaces of the enclosure (26) guide the motion of the carton (22) into the enclosure (26) for filling. A port formed in the enclosure (26) admits sterile fluid to flush the interior of the enclosure (26). The port and the nozzle (24) are connectible into a cleaning solution circuit with the port providing an outlet for cleaning solution that has entered the enclosure (26) through the nozzle (24). The nozzle (24) and the interior of the enclosure (26) may be cleaned by sealing the enclosure (26) from the ambient atmosphere and then flushing the enclosure (26) with the cleaning solution.

This invention relates generally to a method and apparatus for filling serially-presented containers with flowable product.

It is known to enclose partially carton filler nozzles to protect against contamination them and the product which they dispense. For example, the Elopak® P-S120UC machine is a double-indexed carton forming, filling, and sealing machine that includes a box-shaped enclosure surrounding a pair of carton filler nozzles. A carton opening is formed in the bottom of the enclosure and is shaped to receive a pair of open-ended cartons into positions axially aligned with and encompassing respective lower portions of the carton filler nozzles. A lift mechanism lifts cartons into these positions within the enclosure from a conveyor that runs beneath the enclosure, and then lowers the cartons as the cartons are filled.

The P-S120UC machine includes a clean-in-place (CIP) circuit that is arranged to introduce cleaning fluid into the carton filler nozzles and to drain the cleaning fluid from the nozzles as the nozzles are being cleaned in place. A removable cleaning manifold obturates the mouths of the nozzles and connects the nozzles to CIP drain piping. The cleaning manifold directs cleaning solution as interior surfaces of the nozzles are being cleaned, in particular sterilized. To install and remove the manifold an operator must reach into the enclosure.

The P-S120UC machine also includes piping for injecting air passed through a high efficiency particulate air filter (known as HEPA air) into the enclosure to maintain a sterile positive-pressure environment around the nozzles during product dispensing operations. The HEPA piping defines a sterile fluid circuit that is separate from the CIP circuit.

In that machine there are vertical carton guides (four for each carton) which are mounted at the inside of the enclosure and guide the vertical edges of the cartons during their upward movement.

According to one aspect of the present invention, there is provided apparatus for filling serially-presented containers with flowable product, comprising:
a filler nozzle for connecting to a source of said product;
an enclosure partially surrounding the nozzle, except for at least an opening to receive an open-ended container into a position axially aligned with the nozzle; and
a sterile fluid port formed in a wall of the enclosure for forming part of a sterile fluid circuit, so that the interior of the enclosure, those surface portions of the nozzle exposed in the enclosure and those surface portions of any container and any flowable product exposed in the enclosure are flushed by the sterile fluid, in order that a generally sterile, positive-pressure environment may be maintained around the nozzle;
the sterile fluid port and the nozzle being connectible into a cleaning fluid circuit such that the sterile fluid port acts as a cleaning fluid port for cleaning fluid flowing through the enclosure and the nozzle.

Owing to this aspect of the invention, it is possible to simplify the known apparatus.

According to a second aspect of the present invention, there is provided apparatus for filling serially-presented containers with flowable product, comprising:
a filler nozzle for connecting to a source of said product;
an enclosure partially surrounding the nozzle, except for at least an opening to receive an open-ended container into a position axially aligned with the nozzle;
a cleaning fluid circuit including the enclosure and the nozzle, and
a cleaning cover removably attachable across said opening so as to close the opening when said cleaning fluid is to be caused to flow through the enclosure and the nozzle.

According to a third aspect of the present invention, there is provided a method comprising:—
providing an enclosure housing a filler nozzle extending in the enclosure;
removing from a container opening of the enclosure any container present in the enclosure;
sealing the enclosure from the ambient atmosphere; and
flushing the interior of the enclosure with a cleaning fluid.

Owing to those two aspects of the invention, it is possible more effectively to prevent contamination of the product being dispensed.

According to a fourth aspect of the present invention, there is provided apparatus for filling serially-presented containers with flowable product, comprising:
a filler nozzle for connecting to a source of said product;
an enclosure partially surrounding the nozzle, except for at least an opening to receive an open-ended container into a position axially aligned with the nozzle; and
container guides disposed in and integral with the enclosure and serving to guide the motion of a container into the enclosure to around the nozzle for filling.

Owing to this aspect of the invention, it is possible to simplify the provision of the carton guides inside the enclosure and to improve the accuracy of those guides.

In a preferred embodiment, the apparatus, which fills serially-presented paperboard cartons with liquid product while maintaining a sterile, contaminant-free environment in a zone immediately surrounding a carton filler nozzle of the apparatus, comprises the carton filler nozzle, which is connectible to a source of liquid product, an enclosure at least partially surrounding the carton filler nozzle, a carton opening formed in the bottom of the enclosure and shaped to receive an open-ended carton into a position axially aligned with and encompassing a portion of the carton filler nozzle, and a sterile fluid inlet port of the enclosure. The sterile fluid inlet port is connected to a source of sterile fluid and is arranged to admit sterile fluid from the source of sterile fluid into the enclosure such that the interior of the enclosure, the exterior of the filler nozzle, and any carton or liquid product present in the enclosure are flushed by sterile fluid and a generally sterile, positive-pressure fluid environment is maintained around the nozzle. The sterile fluid inlet port and the carton filler nozzle are connectible into a cleaning solution circuit such that the sterile fluid inlet port acts as a cleaning solution outlet port for cleaning solution entering the enclosure through the nozzle. The enclosure may have carton guides formed into its interior surface and arranged to guide the motion of a carton into the enclosure to around the filler nozzle for filling. The cleaning fluid circuit may be an open circuit or a closed circuit, as may be the sterile fluid circuit.

In order that the invention may be clearly and completely disclosed, reference will now be made, by way of example, to the accompanying drawings, in which:

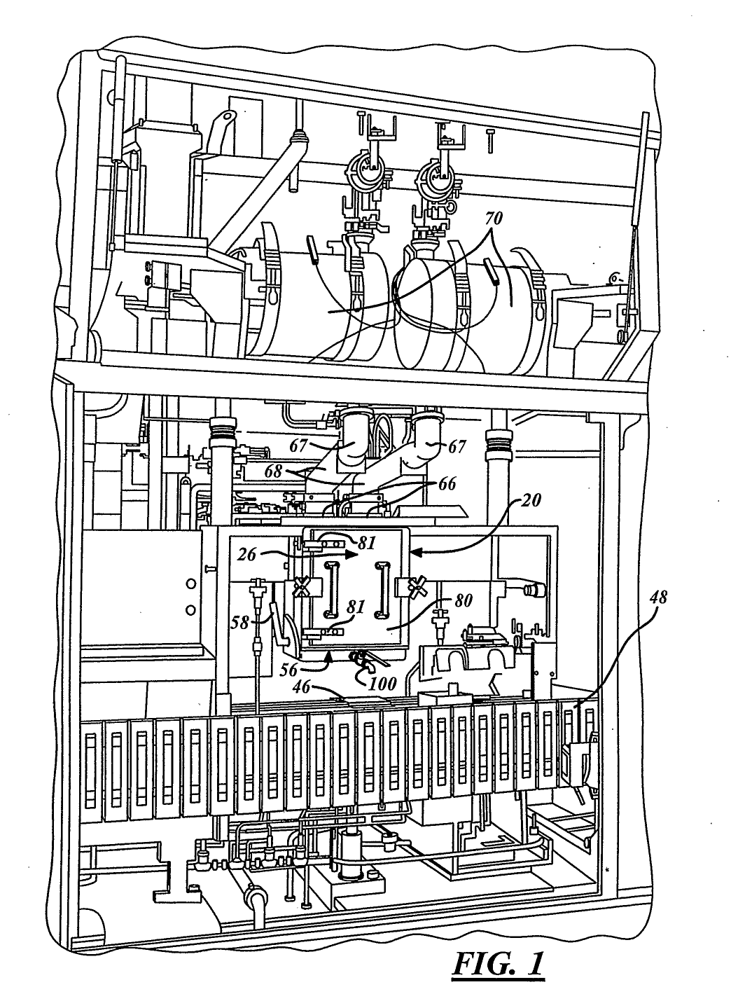

FIG. 1 is a fragmentary perspective view of a form-fill-seal packaging machine;

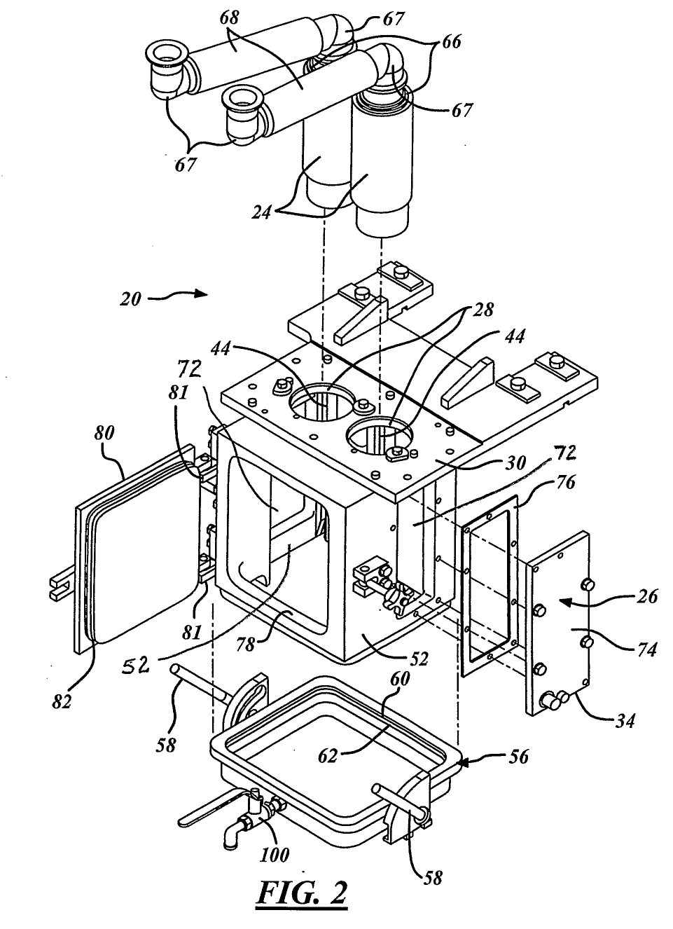

FIG. 2 is an orthogonal exploded view of enclosure and filler tube components of a filling station of the machine;

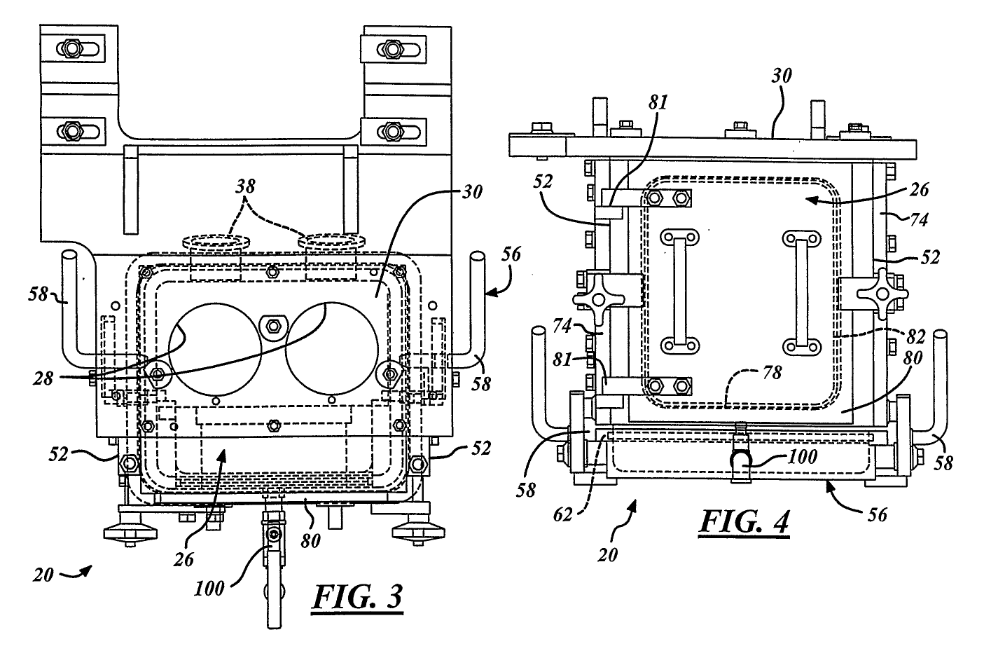

FIG. 3 is a top plan view of the enclosure;

FIG. 4 is a front elevation of the enclosure;

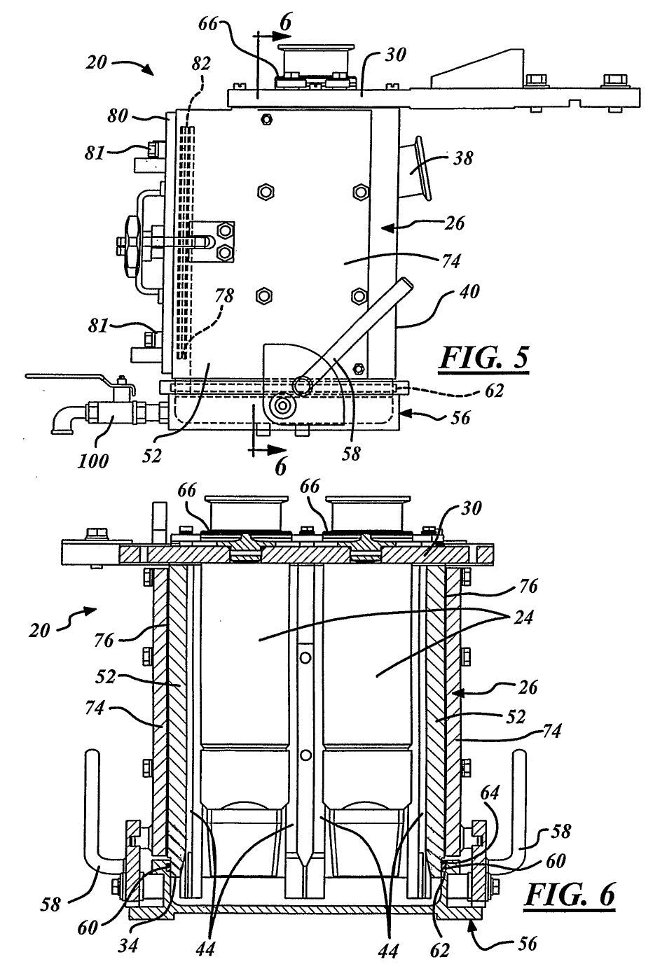

FIG. 5 is a side elevation of the enclosure and parts of the filler tubes;

FIG. 6 shows a vertical section taken along the line 6-6 of FIG. 5;

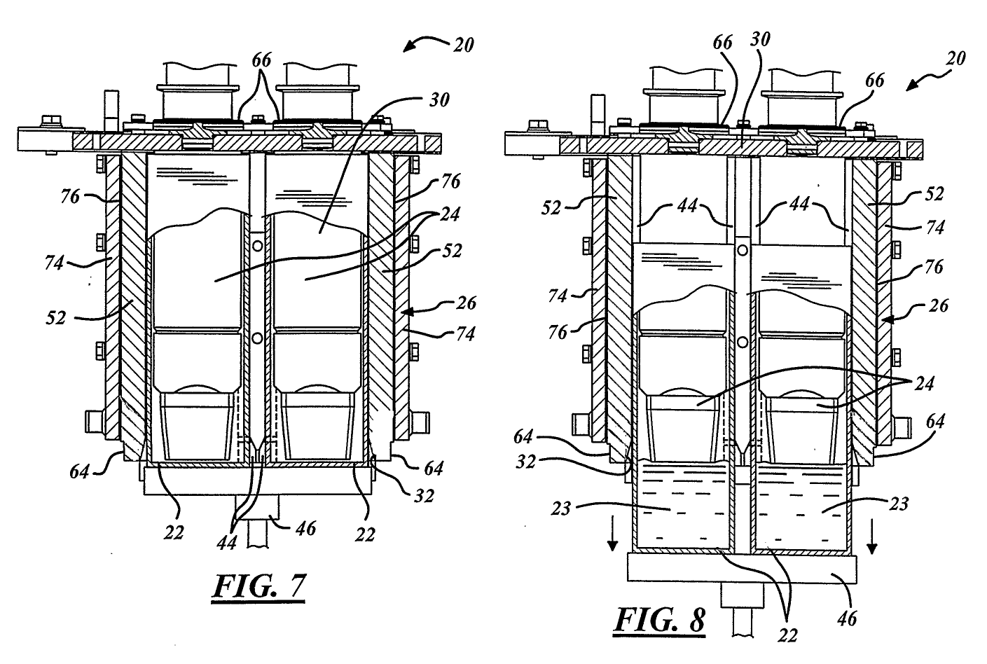

FIG. 7 is a view similar to FIG. 6, but with a cleaning cover removed and two cartons shown in respective fill positions around respective filler nozzles of the filler tubes;

FIG. 8 is a view similar to FIG. 7, but with the two cartons shown being lowered as they are filled with product;

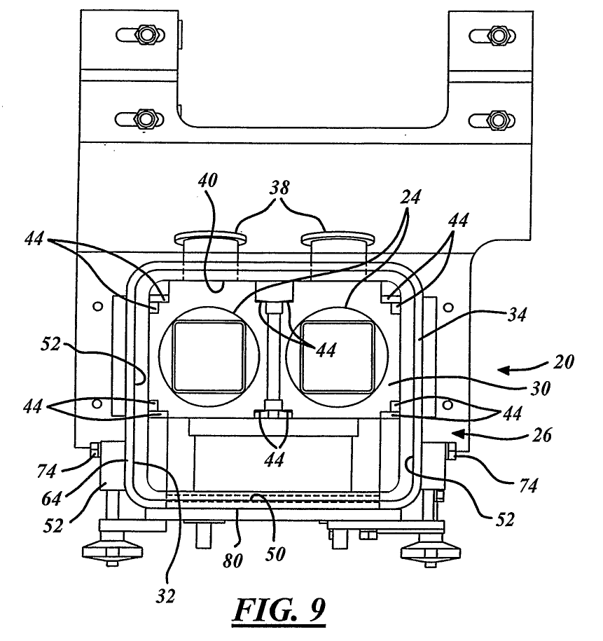

FIG. 9 is an underneath plan view of the enclosure and the filler nozzles;

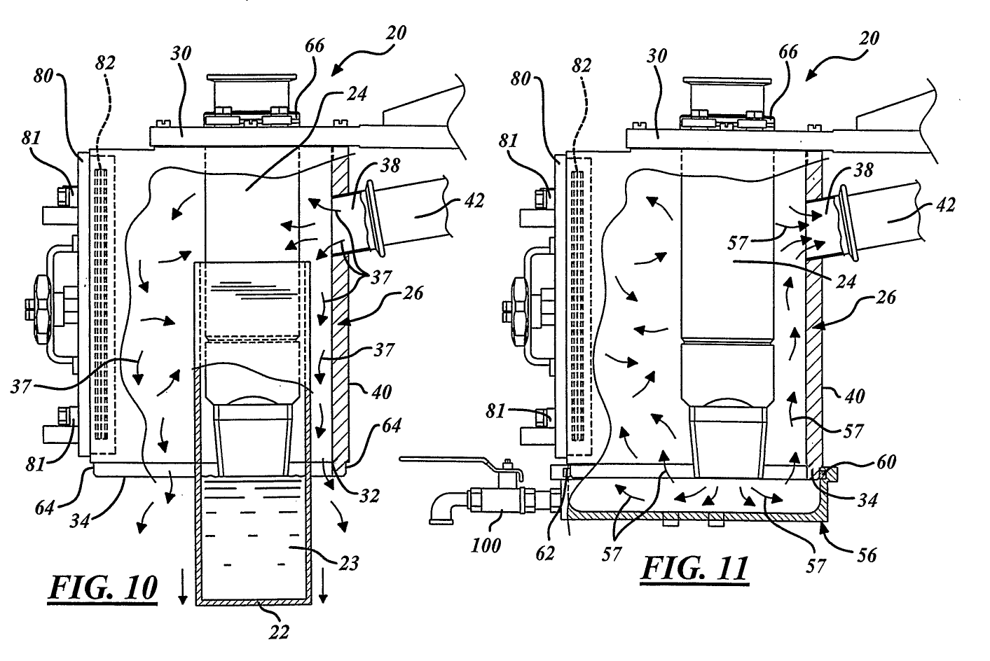

FIG. 10 is a fragmentary, partially sectional, side elevation of the enclosure and the filler tubes showing the cleaning cover removed and the enclosure being flushed with HEPA air as two cartons are being filled with product;

FIG. 11 is a view similar to FIG. 10, but showing the cleaning cover in place and cleaning fluid being passed through the enclosure; and

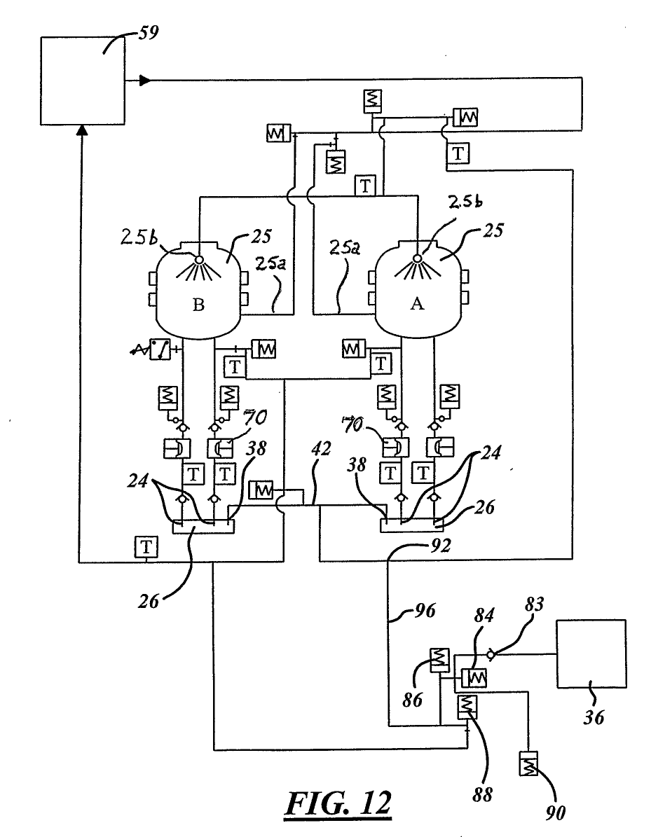

FIG. 12 is a schematic view of fluid circuitry, but for an apparatus with two enclosures.

Unless the context indicates otherwise, the present example is of an apparatus 20 with a single enclosure 26. The apparatus 20 for filling serially-presented paperboard cartons 22 with liquid product 23 from sources 70 (in the form of a pair of filler pumps) of liquid product while maintaining a sterile, contaminant-free environment in a region immediately surrounding a pair of carton filler nozzles 24 of the apparatus 20 is shown in FIGS. 1 to 11. The apparatus 20 includes a generally rectilinear, box-shaped enclosure 26 shaped to surround at least partially the carton filler nozzles 24. As best shown in FIGS. 2 and 3, two generally circular nozzle openings 28 are formed in an upper wall 30 of the enclosure 26 and are shaped to receive the nozzles 24. The apparatus 20 also includes a carton opening, best shown at 32 in FIGS. 9 and 10, that is formed in the bottom 34 of the enclosure 26 and is shaped to receive a pair of open-topped, plastics-coated paperboard cartons 22 into general axial alignment with the nozzles 24 as shown in FIGS. 7, 8, and 10. The apparatus 20 also includes a source 36 of clean, sterile fluid 37, such as HEPA air, and a pair of sterile fluid inlet ports 38 of the enclosure 26. The ports 38 are best shown in FIGS. 5, 9, and 10 to 12. As shown schematically in FIG. 12, the ports 38 are in fluid communication with the source 36 of clean, sterile air and admit the air from the source 36 into the enclosure 26. As shown in FIG. 10, the inlet ports 38 direct the air at the respective nozzles 24 such that the exterior surfaces of the nozzles 24, the interior of the enclosure 26, and the exposed surfaces of any carton 22 or product 23 present in the enclosure 26 are flushed by the air to maintain a more sterile, contaminant-free environment in a region immediately surrounding the nozzles 24. In other words, continuously flushing the enclosure 26 with clean, sterile air creates and maintains a generally sterile, positive-pressure fluid environment around the nozzles 24.

Each of the pair of inlet ports 38 is circular in shape and is provided in a back wall 40 of the enclosure 26 as shown in FIGS. 9 to 11. A pair of air lines 42 is connected to the inlet ports 38 so that clean sterile air can be pumped into the enclosure 26 through the ports 38. This creates an overpressure environment within the enclosure 26 and around the nozzles 24 to keep the nozzles clean and sterile as they fill the cartons 22 with the product 23.

As shown in FIGS. 6 to 9, eight vertically-oriented carton guides 44 form corners within the enclosure 26 and are shaped and positioned, by machining of the interior surface of the enclosure 26, to guide the motion of two open-topped cartons 22 at a time when a carton lifter 46 simultaneously lifts the cartons from a conveyor 48 through the carton opening 32 into respective initial fill positions, and thereafter lowers the cartons. In the fill positions shown in FIG. 7, the open tops of the cartons 22 surround the respective nozzles 24. Once the nozzles 24 begin filling the cartons 22 with the product 23, the carton lifter 46 begins lowering the cartons 22 back down to the conveyor 48. The carton lifter 46 lowers the cartons 22 at a rate that maintains the surface level of the product 23 in the cartons 22 at an approximately constant level relative to the enclosure 26, as shown in FIGS. 8 and 10. As best shown in FIG. 9, the eight carton guides 44 are vertically-oriented structures of the enclosure 26 and slidably receive respective top corners and vertical edges of a pair of cartons 22 carried by the carton lifter 46 as the lifter cycles up and down.

A generally rectangular cleaning cover, shown at 56 in FIGS. 1 to 6 and 11, is removably attachable across the opening 32 to allow a cleaning solution 57 to be prevented from falling from the enclosure 26 when the nozzles 24 and the interior of the enclosure 26 are periodically cleaned as shown in FIG. 11. The cover 56 has exterior latches 58 that allow an operator to lock the cover 56 into position across the opening 32 without contaminating the nozzles 24 or the enclosure interior by touching the nozzles 24 or the guides 44. This allows the nozzles 24 and the enclosure interior to be cleaned in place and sterilized without danger of recontamination. In other words, the insides and outsides of the nozzles 24 and the guides 44 and their environment can be cleaned, particularly sterilized, without any human contact with those structures.

As shown in FIGS. 2, 6, and 11, a rubber seal 60 is supported in a seal receptacle 62 formed along and adjacent to a periphery of the cover 56 and is positioned to engage a seal contact surface 64 surrounding the opening 32 to seal-in the cleaning solution 57 and the pressure used to clean the nozzles 24 and the interior of the enclosure 26. The seal 60 is of substantially rectangular cross-section, maybe rounded at its cross-sectional corners, and is supported in the seal receptacle 62 of the cover 56 so that, when the cover 56 is removed, the seal 60 stays with the cover 56. The seal contact surface 64 is disposed on an outside lower edge zone of the enclosure 26 surrounding the opening 32, rather than on an interior surface of the carton opening 32, to ensure that all of the inside surface of the enclosure 26 can be swept by the cleaning solution 57.

Annular flanges 66 are provided around the nozzles 24 and form seals between the nozzles 24 and the upper wall 30 of the enclosure 26 where the nozzles 24 enter the upper wall 30 through the pail of circular openings 28. As shown in FIG. 1, filler elbows 67 and arms 68 are provided; they connect the pair of nozzles 24 to the respective filler pumps 70.

As best shown in FIG. 2, the opposing side walls 52 of the enclosure 26 have respective, generally rectangular, side access openings 72 covered by respective, generally rectangular, gasketed, removable, side access panels 74. The positions of the gaskets 76 for the side access panels 74 are best shown in FIGS. 2 and 6 to 8. The front wall 50 of the enclosure 26 has a generally rectangular front access opening 78 coverable by a generally rectangular, front access panel (in this case a hinged door) 80 that is supported on hinges 81 and can be opened as shown in FIG. 2 to allow access to the filler nozzles 24 so that worn parts, such as rubber nozzle ends, screens, or springs can be removed and replaced. As best shown in FIG. 2, the front access door 80 carries a door seal ring 82 that seals between the door 80 and the front access opening 78 when the door 80 is closed.

In practice, a sterile, contaminant-free environment can be maintained in a region immediately surrounding the carton filler nozzles 24 during filling operations by providing and maintaining a generally clean, sterile, positive-pressure fluid environment within the enclosure 26 and around the nozzles 24. This is done by moving HEPA air into the enclosure 26 from the source 36 of HEPA air through the ports 38, as shown in FIG. 10. More specifically, and referring to FIG. 12, HEPA air is routed from its source 36 through a check valve 83, a HEPA blocking valve 84, and then a HEPA valve 86. A CIP return valve 88 is closed and a CIP drain valve 90 is closed. The HEPA air then travels through a tee 92 and into the enclosure 26 through the ports 38. The apparatus may include two (as shown in FIG. 12) or more enclosures 26 rather than just a single enclosure.

The filler nozzles 24 and the enclosure interior can be periodically cleaned by first removing any cartons 22 present in the enclosure 26. Any cartons 22 present in the enclosure 26 are removed by actuating the carton lifter 46 to lower the cartons 22 back down to the conveyor 48. The cover 56 is then removably and sealingly attached across the opening 32. If the side access panels 74 have been removed for any reason they are removably and sealingly re-attached across the side access openings 72. If the front access door 80 has been removed or opened, it also is removably and sealingly secured across the front access opening 78. Once the enclosure 26 has been sealed, it is flushed with a cleaning solution 57 as shown in FIG. 11. Referring to FIG. 12, to flush the enclosure, cleaning solution 57 is introduced into a filler tank 25, via input lines 25a and/or via spray nozzles 25b, and thence by way of the pair of filler pumps 70 and the nozzles 24 into the enclosure 26 from a source 59 of cleaning fluid, is allowed to circulate round the interior of the enclosure 26, and is forced or drawn out of the enclosure 26 through the ports 38 and the piping 96 that, in normal operation, carry HEPA air to the enclosure 26. As cleaning fluid is flowing through the HEPA piping 96, the HEPA valve 86 and the CIP return valve 88 are cycled open, allowing fluid to flow through them and exit through the CIP drain valve 90. This cleans and sterilizes the HEPA circuit. Also, during this time, while the HEPA valve 86 and the CIP drain valve 90 are open, the HEPA blocking valve 84 is pulsed open. This allows a valve seat of the HEPA blocking valve 84 to be cleaned. Residual cleaning solution 57 is drained from the enclosure 26 by opening a drain valve 100 carried by the cover 56. Fluid remaining in the cover 56 can then flow out through the valve 100 and an attached drain tube.

In the embodiment described with reference to the drawings, the carton filling process can be conducted in a clean, sterile, environment, protecting the product 23 from contaminants, the enclosure 26 and the nozzles 24 can be cleaned without requiring an operator to reach into the enclosure 26, and the sterile fluid inlet port 38 can be used to circulate cleaning solution 57 as part of the CIP circuit rather than incorporating a separate port in the CIP circuit for discharging cleaning solution 57 from the enclosure 26.

1-28. (canceled)

29. Apparatus for filling serially-presented containers with flowable product, comprising:
a filler nozzle for connecting to a source of said product;
an enclosure partially surrounding the nozzle, except for at least an opening to receive an open-ended container into a position axially aligned with the nozzle; and
a sterile fluid port formed in a wall of the enclosure for forming part of a sterile fluid circuit, so that the interior of the enclosure, those surface portions of the nozzle exposed in the enclosure and those surface portions of any container and any flowable product exposed in the enclosure are flushed by the sterile fluid, in order that a generally sterile, positive-pressure environment may be maintained around the nozzle;
the sterile fluid port and the nozzle being connectible into a cleaning fluid circuit such that the sterile fluid port acts as a cleaning fluid port for cleaning fluid flowing through the enclosure and the nozzle.

30. Apparatus according to claim 29, wherein said sterile fluid port is a sterile fluid inlet port for connecting to a source of the sterile fluid and admitting the sterile fluid into the enclosure.

31. Apparatus according to claim 29, wherein said sterile fluid port is connectible into said cleaning fluid circuit such that said sterile fluid port acts as a cleaning fluid outlet port for the cleaning fluid, which enters the enclosure through the nozzle.

32. Apparatus according to claim 29, in which the sterile fluid is air passed through a high-efficiency particulate air filter.

33. Apparatus according to claim 29 and further comprising a cleaning cover removably attachable across said opening so as to close the opening when said cleaning fluid is to be caused to flow through the enclosure and the nozzle.

34. Apparatus according to claim 33, in which the cleaning cover is such as to allow an operator to lock the cover into position across the opening without touching the nozzle or the interior surface of the enclosure.

35. Apparatus according to claim 33, and further comprising an annular, resilient seal which is supported in an annular receptacle formed along and adjacent to a periphery of the cover and which is positioned to engage a contact surface of said enclosure surrounding the opening.

36. Apparatus according to claim 35, in which the contact surface is disposed on an outside lower edge zone of the enclosure surrounding the opening.

37. Apparatus according to claim 35, wherein said seal is of substantially rectangular cross-section.

38. Apparatus according to claim 33, and further comprising a drain valve carried by the cover.

39. Apparatus according to claim 29, in which the enclosure has a front access opening coverable by a front access panel.

40. Apparatus according to claim 29, wherein the enclosure has at least one side access opening, the or each of which is coverable by a side access panel.

41. Apparatus according to claim 29 and further comprising container guides disposed in and integral with the enclosure and serving to guide the motion of a container into the enclosure to around the nozzle for filling.

42. Apparatus according to claim 41, in which the guides have been formed by machining of said enclosure.

43. Apparatus for filling serially-presented containers with flowable product, comprising:
a filler nozzle for connecting to a source of said product;
an enclosure partially surrounding the nozzle, except for at least an opening to receive an open-ended container into a position axially aligned with the nozzle;
a cleaning fluid circuit including the enclosure and the nozzle, and
a cleaning cover removably attachable across said opening so as to close the opening when said cleaning fluid is to be caused to flow through the enclosure and the nozzle.

44. Apparatus according to claim 43, in which the cleaning cover is such as to allow an operator to lock the cover into position across the opening of the enclosure without touching the nozzle or the interior surface of the enclosure.

45. Apparatus according to claim 43, and further comprising an annular, resilient seal which is supported in an annular receptacle formed along and adjacent to a periphery of the cover and which is positioned to engage a contact surface of said enclosure surrounding the opening.

46. Apparatus according to claim 45, in which the contact surface is disposed on an outside lower edge zone of the enclosure surrounding the opening.

47. Apparatus according to claim 45, wherein said seal is of substantially rectangular cross-section.

48. Apparatus according to claim 43, and further comprising a drain valve carried by the cover.

49. Apparatus for filling serially-presented containers with flowable product, comprising:
a filler nozzle for connecting to a source of said product;
an enclosure partially surrounding the nozzle, except for at least an opening to receive an open-ended container into a position axially aligned with the nozzle; and
container guides disposed in and integral with the enclosure and serving to guide the motion of a container into the enclosure to around the nozzle for filling.

50. Apparatus according to claim 49, in which the guides have been formed by machining of said enclosure.

51. A method comprising:—
providing an enclosure housing a filler nozzle extending in the enclosure;
removing from a container opening of the enclosure any container present in the enclosure;
sealing the enclosure from the ambient atmosphere; and
flushing the interior of the enclosure with a cleaning fluid.

52. A method according to claim 51, in which said sealing comprises removably attaching a cleaning cover across the opening.

53. A method according to claim 52 and further comprising, after said flushing of the interior of the enclosure with the cleaning fluid, draining such cleaning fluid from the cover by opening a drain valve carried by the cover.

54. A method according to claim 51, in which said sealing includes removably securing a side access panel across a side access opening of the enclosure.

55. A method according to claim 51, in which said sealing includes closing a front access opening of the enclosure.

56. A method according to claim 51, and further comprising, prior to said removing, said sealing and said flushing, flushing, with sterile fluid passing through a sterile fluid port of said enclosure, said interior, those surface portions of the nozzle exposed in the enclosure and those surface portions of any container and any flowable product exposed in the enclosure, in order that a generally sterile, positive-pressure environment may be maintained around the nozzle, wherein said flushing of the interior of the enclosure with said cleaning fluid includes introducing said cleaning fluid into the enclosure through the filler nozzle, the cleaning fluid exiting the enclosure through said port.
